(19) United States
(12) Patent Application Publication
(10) Pub. No.: US 2004/0261521 A1
(43) Pub. Date: Dec. 30, 2004

(54) Flow sensor having two heating resistors

(76) Inventors: Hans Hecht, Korntal-Muenchingen (DE); Matthias Fuertsch, Gomaringen (DE); Heribert Weber, Nuertingen (DE); Klaus Reymann, Gerlingen (DE); Uwe Konzelmann, Asperg (DE)

Correspondence Address: KENYON & KENYON, ONE BROADWAY, NEW YORK, NY, 10004, US

(21) Appl. No.: 10/851,605

(22) Filed: May 21, 2004

(30) Foreign Application Priority Data
May 21, 2003 (DE) 10324290.2

(51) Int. Cl. G01F 1/68

(52) U.S. Cl. 73/204.26

(57) ABSTRACT

A flow sensor, in particular an air mass sensor, in which two heating resistors are used and a temperature sensor is assigned to each of these heating resistors. This makes more accurate and rapid measurement of the mass of air possible.

### FIELD OF THE INVENTION

The present invention is directed to a flow sensor having two heating resistors and at least one reference temperature sensor for determining the ambient temperature.

### BACKGROUND INFORMATION

A flow sensor is known from European Patent Application No. EP 0 955 524. It is used for determining the mass of air being aspirated by an internal combustion engine. The flow sensor described in European Patent Application No. EP 0 955 524 has two heating resistors and two reference temperature sensors. The reference temperature sensors detect the ambient temperature, i.e. the temperature of the air flowing past the flow sensor, unaffected by the heating resistors. The two heating resistors are used to measure the mass of air flowing over the flow sensor. Here, use is made of the effect that the upstream heating resistor heats up the air flowing over it and in consequence the downstream heating resistor needs less thermal energy to reach a specified temperature. The differing cooling of the upstream and downstream heating resistors causes a difference in their electrical resistance. This difference constitutes a measure for the mass flow of air flowing past the flow sensor.

The temperature-dependent resistances R(T) of the heating resistors which are to be measured are derived from the following formula:

R(T)=R₀(1+a×T)

where

R₀=resistance at ambient temperature

a=temperature coefficient of the heating resistor and

T=temperature

This equation makes it clear that the temperature-dependent resistance R(T) is strongly dependent on resistance R₀. In order to achieve an adequate electrical calorific output, the resistances of the heating resistors have to be kept low. However, this requirement goes against the need for the flow sensor to be as sensitive and accurate as possible, since a low resistance figure at ambient temperature results in only a small temperature-induced change in resistance.

In addition, structural changes and electron migration effects and/or recrystallization effects occur in the heating resistors as they are impacted by relatively large flows of air, owing to the heating resistors' increased temperature. Both of these effects result in an irreversible change in the resistance and thus to an error in determining the mass flow of air.

### SUMMARY OF THE INVENTION

In the flow sensor according to the present invention, having two heating resistors and at least one reference temperature sensor for determining the ambient temperature, an additional temperature sensor is assigned to each heating resistor for determining the temperature of the heating resistor, the temperature sensors being situated in the immediate vicinity of the heating resistors.

This measure results in a separation of functions. The heating resistor now has the sole function of reaching a specified temperature, while the temperature sensor surrounding it measures the temperature of the heating resistor. This makes it possible to carry out temperature measurement using a temperature sensor having a high electrical resistance, thereby increasing the accuracy of the flow sensor. In addition, the flow-induced structural and recrystallization effects referred to above do not occur in the temperature sensors, with the result that the accuracy of the flow sensor remains virtually constant throughout its working life.

Here, it has proved to be advantageous to have the temperature sensors and the heating resistors largely enclosing each other, with the result that the temperatures determined by the temperature sensors are virtually identical to the temperature of the heating resistors and the delay between a temperature change in the heating resistor and the resultant temperature change in the temperature sensor is kept as short as possible.

In an advantageous embodiment of the flow sensor according to the present invention, the current through each heating resistor is regulated separately and the difference in the currents or voltages across the temperature sensors is used to measure the flow and to determine the direction of flow. This makes a rapid and more accurate measurement of the flow possible since regulation of the current or voltage across the heating resistors takes place very rapidly, and there is a large difference in the currents flowing through the temperature sensors or the voltages across the temperature sensors. This causes a large output signal from the flow sensor according to the present invention, which can be easily evaluated and processed in the controller of the internal combustion engine.

It has been shown to be advantageous if the current across the heating resistors is regulated as a function of the ambient temperature or of the temperature of the air flowing over the flow sensor, and particularly advantageous if the temperature of the heating resistors exceeds the ambient temperature by a fixed amount ΔT.

The accuracy of the flow sensor according to the present invention is further increased if the temperature sensors have a much higher resistance than the heating resistors.

In a particularly advantageous design of the flow sensor according to the present invention, the measuring element of the flow sensor has a substrate, a diaphragm is supported by the substrate, and a resistor layer is applied to the substrate and the diaphragm, the heating resistors, the temperature sensors, and at least one reference temperature sensor being structured out of it. Here, it is advantageous if the reference temperature sensor is placed above the substrate and both the heating resistors and the temperature sensors are situated essentially above or within the diaphragm.

By this design of the measuring element the manufacture of the flow sensor according to the present invention may be simplified and the costs thereof kept low, without negative impacts on the operating performance of the flow sensor.

It is naturally also possible for the leads used to make the contacts between the heating resistors and the temperature sensors and the reference temperature sensor(s) to be structured out of the resistor layer. The printed conductor tracks forming the heating resistors may be of different widths, in order to achieve the most even and advantageous heat dissipation possible.

The behavior of the temperature sensors may be evaluated by means of a four-point measurement or a Wheatstone bridge.

It may also be advantageous if a second reference temperature sensor is provided and the heating resistors and/or the temperature sensors are each supplied with electrical current via a shared printed conductor track. This measure makes it possible to reduce the size of the measuring element and the manufacturing effort required.

### BRIEF DESCRIPTION OF THE DRAWINGS

FIG. 1 shows a first exemplary embodiment of a measuring element according to the present invention in a flow sensor having temperature sensors situated inside.

FIG. 2 shows a second exemplary embodiment having temperature sensors situated outside.

FIGS. 3 and 4 show different variants of the measuring elements shown in FIGS. 1 and 2.

FIG. 5 shows a measuring element in which the heating resistors have a joint ground connection.

FIG. 6 shows a measuring element in which the temperature sensors have a joint ground.

FIG. 7 shows a variant with the heating resistors being locally of different widths.

FIG. 8 shows a measuring element having an array of temperature sensors for a four-point measurement.

FIG. 9 shows a measuring element having temperature measuring sensors which may be connected together to form a Wheatstone bridge.

FIG. 10 shows a circuit diagram of an exemplary embodiment of a flow sensor according to the present invention.

### DETAILED DESCRIPTION

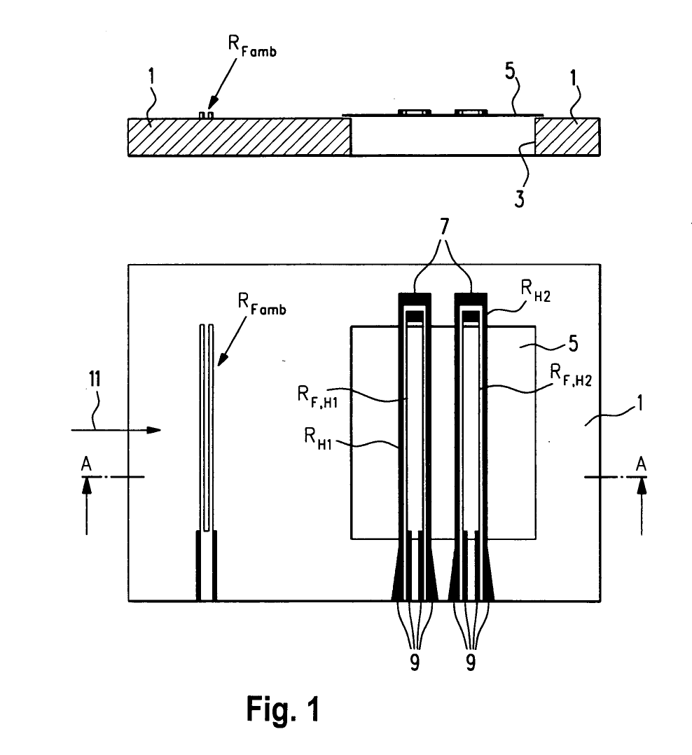

FIG. 1 shows schematically a first exemplary embodiment of a measuring element in a flow sensor according to the present invention, viewed from above and also viewed in cross-section along the line A-A. The measuring element of the flow sensor has a substrate 1, which, for example, may be made of silicon. A reference temperature sensor R_{Famb} is placed on substrate 1.

Substrate 1 has a recess 3 which is covered by a thin diaphragm 5, having poor thermoconducting characteristics. Two U-shaped heating resistors R_{H1} and RH₂ extend across diaphragm 5, as far as substrate 1. Heating resistors R_{H1} and R_{H2} are electrically connected to a regulated source of voltage or current, not shown.

Temperature sensors R_{F,H1} and R_{F,H2} are situated within U-shaped heating resistors R_{H1} and R_{H2}. Temperature sensors R_{F,H1} and R_{F,H2} have the function of determining the temperature of heating resistors R_{H1} and R_{H2}. In order to be able to determine the temperature of heating resistors R_{H1} and R_{H2} as accurately as possible and with only a short delay, temperature sensors R_{F,H1} and R_{F,H2} are situated in the immediate vicinity of heating resistors R_{H1} and R_{H2}. The electrical resistances of temperature sensors R_{F,H1} and R_{F,H2}are much higher than those of heating resistors R_{H1} and R_{H2}. Temperature sensors R_{F,H1} and R_{F,H2} are electrically connected to an evaluation circuitry, not shown.

In the first exemplary embodiment, heating resistors R_{H1} and R_{H2} and temperature sensors R_{F,H1} and R_{F,H2} extend beyond diaphragm 5. Where temperature sensors R_{F,H1} and R_{F,H2} extend beyond diaphragm 5, at least where they form a cross-piece 7 they are much wider than where they are situated above diaphragm 5, with the result that heating resistors R_{H1} and R_{H2} and temperatures sensors R_{F,H1} and R_{F,H2} have only a very low resistance in the sections forming the cross-piece 7 and thus the measurement result is impacted only slightly by the portion of temperature sensors R_{F,H1} and R_{F,H2} situated outside diaphragm 5.

The terminals of temperature sensors R_{F,H1} and R_{F,H2} and of heating resistors R_{H1} and R_{H2}are indicated by reference number 9.

An arrow 11 indicates the direction of flow of the air passing over the measuring element. This means that reference temperature sensor R_{Famb} measures the temperature of the incoming air without it being affected by heating resistors R_{H1} and R_{H2}. Upstream heating resistor R_{H1} is impacted by the air, and cooled thereby. At the same time, the air removes heat from upstream heating resistor R_{H1} and consequently heats up downstream heating resistor R_{H2}.

The temperature of upstream heating resistor R_{H1} is regulated to a specified value by a regulation device, not shown. This setpoint value is generally higher by a constant differential amount ΔT than the ambient temperature T_{amb} determined by reference temperature sensor R_{Famb}. Downstream heating resistor R_{H2} is regulated to the same temperature as the upstream one, namely T_{amb}+ΔT. Since downstream heating resistor R_{H2} has heated air flowing over it, the required thermal energy at downstream heating resistor R_{H2} is less than that at upstream resistor R_{H2}. This difference in thermal energy, which may be expressed in the case of the temperature sensors as a voltage difference or a current difference or a combination of both, is a measure for the mass flow of the air passing over the measuring element. At the same time, the direction of flow of the air may also be determined by whether this difference is positive or negative.

Reference temperature sensor R_{Famb}, heating resistors R_{H1} and R_{H2} and temperature sensors R_{F,H1} and R_{F,H2} are etched out of a resistor layer which has been applied to substrate 1 and diaphragm 5. This makes it possible to manufacture the required electrical components on the substrate 1 and diaphragm 5 simply and by a method known heretofore.

The underlying design of the embodiments shown in FIGS. 1 through 9 for measuring elements according to the present invention in flow sensors is essentially the same. Consequently, in the following text, only the differences will be mentioned, and the same reference numbers will be used.

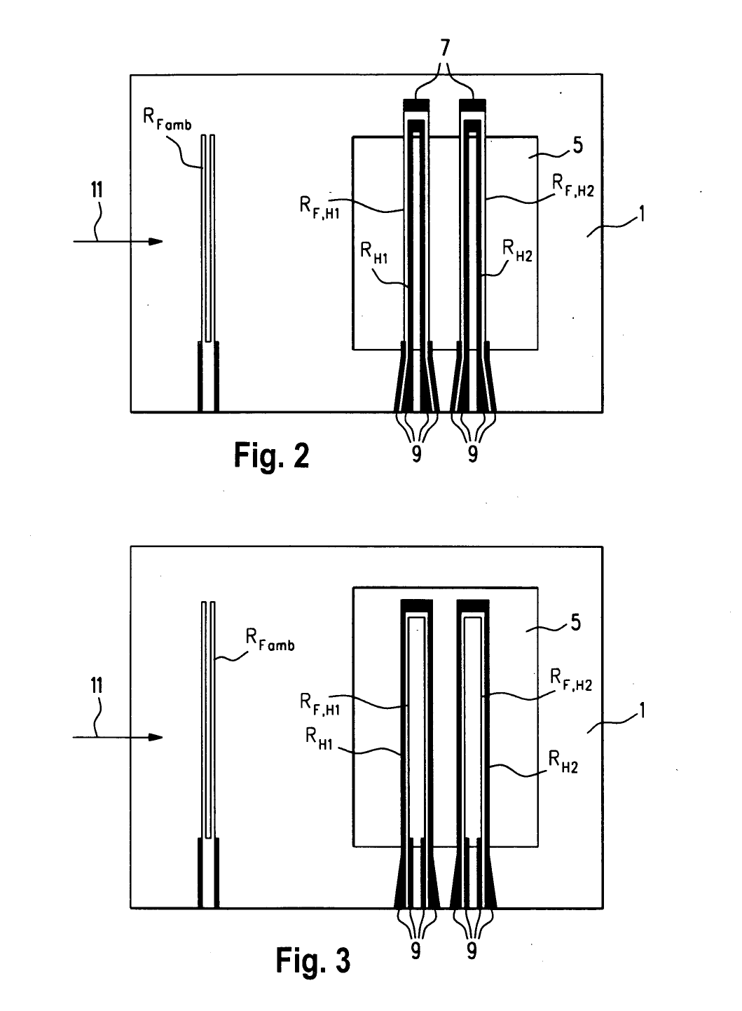

FIG. 2 shows an alternative embodiment, in which unlike the exemplary embodiment shown in FIG. 1, temperature sensors R_{F,H1} and R_{F,H2} are situated outside heating resistors R_{H1} and R_{H2}.

In the exemplary embodiment shown in FIG. 3, heating resistors R_{H1} and R_{H2} and temperatures sensors R_{F,H1} and R_{F,H2} are kept within the bounds of diaphragm 5, with the exception of their terminals 9. Consequently, the width of temperature sensors R_{F,H1} and R_{F,H2} is also constant over their entire length. In the exemplary embodiment shown in FIG. 3 temperature sensors R_{F,H1} and R_{F,H2} are situated within heating resistors R_{H1} and R_{H2}.

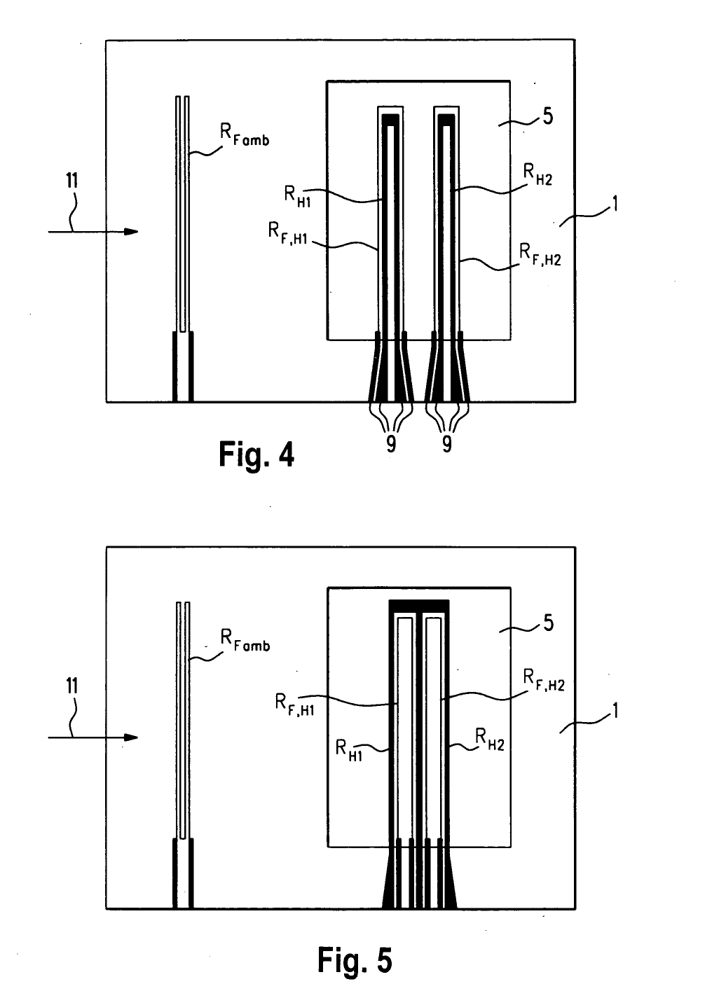

FIG. 4 shows a further exemplary embodiment, in which temperature sensors R_{F,H1} and R_{F,H2} are situated outside heating resistors R_{H1} and R_{H2}.

In the exemplary embodiment shown in FIG. 5, heating resistors R_{H1} and R_{H2} share a common ground, with the result that one fewer terminal is needed. In this design, it is not essential for the shared ground to be located within the area of diaphragm 5: if required it may also be located outside it.

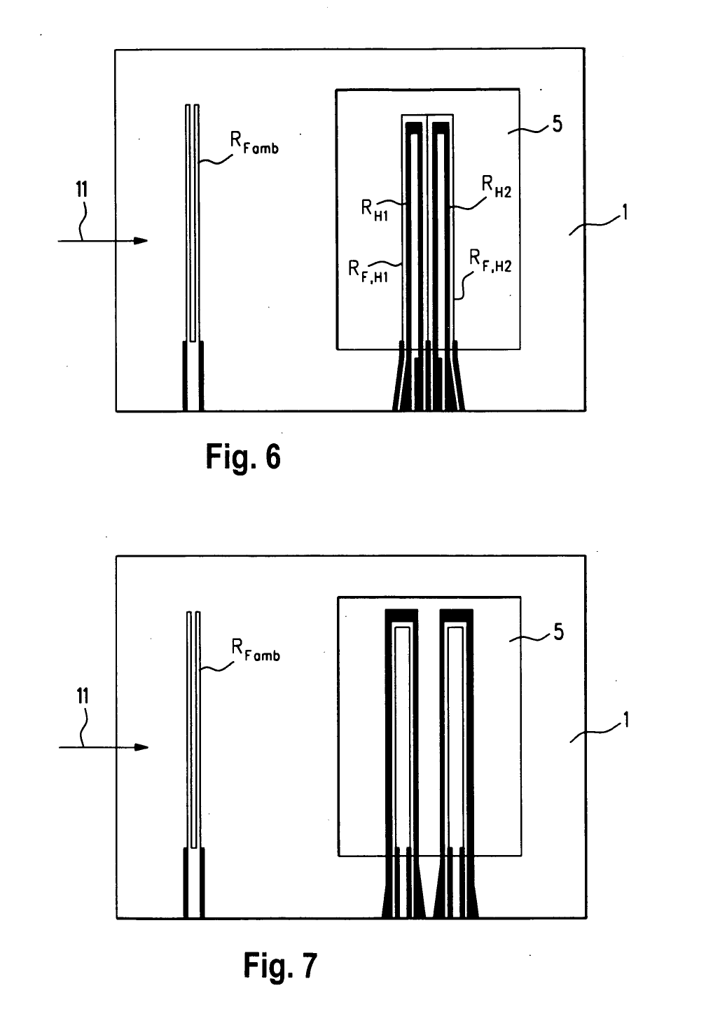

In FIG. 6, temperature sensors R_{F,H1} and R_{F,H2} are joined in the middle, with the result that here too one terminal may be eliminated. In this case, too, it is not necessary for the common ground to be located within the area of diaphragm 5.

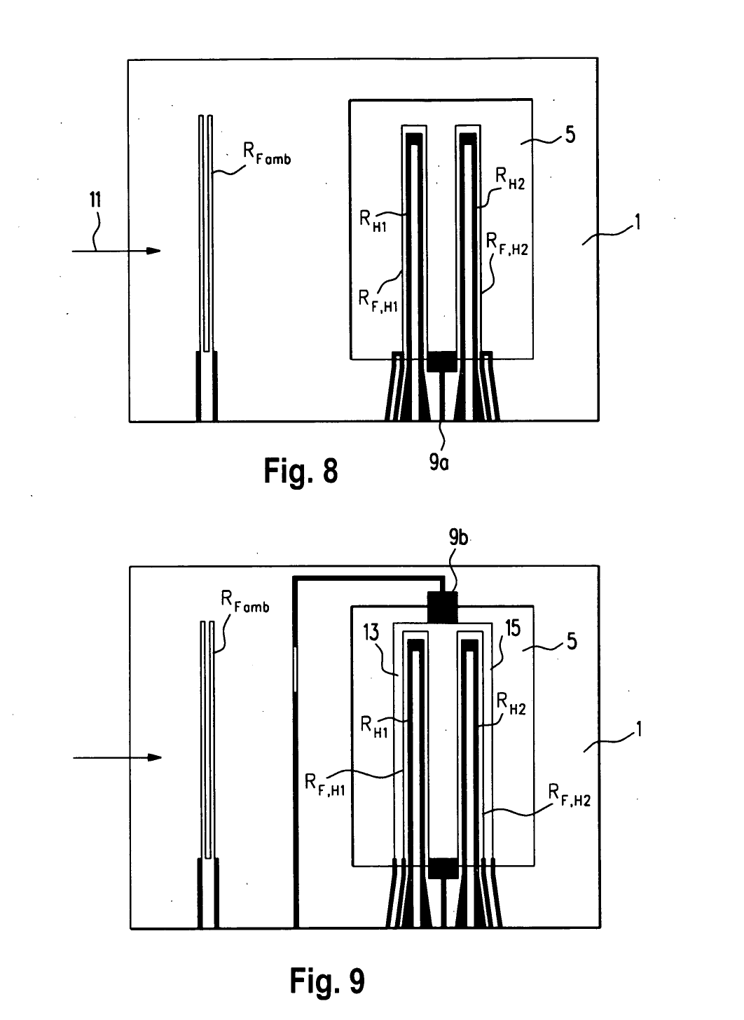

FIG. 7 shows an exemplary embodiment in which the two legs of the U-shaped heating resistors R_{H1} and R_{H2}are of differing widths. In upstream heating resistor R_{H1}, the upstream leg is wider than the one facing downstream heating resistor R_{H2}. In downstream heating resistor R_{H2}, the leg facing upstream heating resistor R_{H1} is narrower than the downstream leg of downstream heating resistor R_{H2}. This design gives improved symmetry in the temperature distribution over diaphragm 5.

It is evident that the widths and shape of heating resistors R_{H1} and R_{H2}, and also the widths and shape of temperature sensors R_{F,H1} and R_{F,H2}, may be matched to differing requirements, such as, for example, a regular temperature pattern or other requirement.

In the exemplary embodiment shown in FIG. 8, while temperature sensors R_{F,H1} and R_{F,H2} are separated in the area of diaphragm 5, terminals 9a and 9b receive the same current. This variant is particularly suitable for determining the resistance of temperature sensors R_{F,H1} and R_{F,H2} by means of four-point measurements between terminals 9c and 9d or 9d and 9e.

FIG. 9 shows an exemplary embodiment in which the resistances of temperature sensors R_{F,H1} and R_{F,H2} may be evaluated by means of a Wheatstone bridge, not shown. For this purpose, in addition to temperature sensors R_{F,H1} and R_{F,H2}, additional resistors 13 and 14 are provided, which receive voltage through a shared terminal 9b.

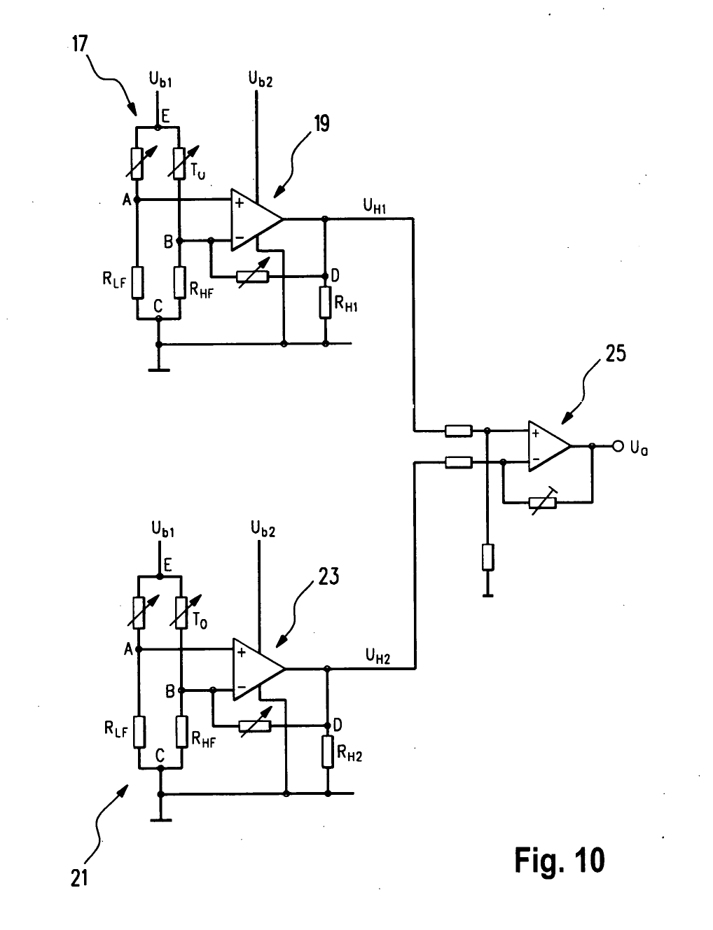

FIG. 10 shows a circuit diagram of a circuitry for evaluating the measuring elements shown in FIGS. 1 through 9. Voltage U_{H1} across upstream heating resistor R_{H1} and voltage U_{H2} present at downstream heating resistor are regulated. This takes place by means of a first bridge circuitry 17 and a first differential amplifier 19. With this circuitry, voltage U_{H1} across upstream heating resistor R_{H1} is regulated such that heating resistor R_{H1} is at the desired temperature T=T_{amb}+ΔT. Similarly, voltage U_{H2} across downstream heating resistor U_{H2} is regulated by means of a second bridge circuit 21 and a second differential amplifier 23. Voltages U_{H1} and U_{H2} are passed to a subtraction element 25 which generates an output voltage U_{A}. This output voltage U_{A} is a measure for the mass flow of air passing over the measuring element and the output signal of the flow sensor, and may be processed in an evaluation circuitry or alternatively by the controller of an internal combustion engine.

What is claimed is:

1. A flow sensor comprising:
first and second heating resistors;
at least one reference temperature sensor for determining an ambient temperature; and
first and second additional temperature sensors, situated in an immediate vicinity of the first and second heating resistors, and assigned to the first and second heating resistors, respectively, for determining a temperature of the first and second heating resistors, respectively.

2. The flow sensor according to claim 1, wherein the first and second additional temperature sensors and the first and second heating resistors substantially enclose one another.

3. The flow sensor according to claim 1, wherein a current across each of the heating resistors is regulated separately, and a difference in one of (a) currents across the additional temperature sensors and (b) voltages across the additional temperature sensors is used to measure a flow and to recognize a direction of flow.

4. The flow sensor according to claim 2, wherein a current across the heating resistors is regulated as a function of the ambient temperature.

5. The flow sensor according to claim 3, wherein the heating resistors are regulated to a temperature which exceeds the ambient temperature by a specified amount.

6. The flow sensor according to claim 1, wherein the additional temperature sensors have a higher resistance than the heating resistors.

7. The flow sensor according to claim 1, further comprising:
a measuring element including a substrate;
a diaphragm supported by the substrate; and
a resistor layer situated on the substrate and the diaphragm, from which the heating resistors, the additional temperature sensors and the at least one reference temperature sensor are structured out of the resistor layer.

8. The flow sensor according to claim 7, wherein the reference temperature sensor is situated above the substrate, and both the heating resistors and the additional temperature sensors are situated substantially above the diaphragm.

9. The flow sensor according to claim 7, further comprising leads for making contacts between the heating resistors and the additional temperature sensors, the leads being structured out of the resistor layer.

10. The flow sensor according to claim 7, wherein widths of a printed conductor track forming the heating resistors are different section-by-section.

11. The flow sensor according to claim 1, wherein the additional temperature sensors are evaluated by one of a four-point measurement and a Wheatstone bridge.

12. The flow sensor according to claim 1, wherein the flow sensor is used for determining a mass flow of air.

13. The flow sensor according to claim 1, wherein the at least one reference temperature sensor includes two reference temperature sensors.

14. The flow sensor according to claim 1, further comprising a shared printed conductor track for supplying with electrical power at least one of (a) the heating resistors and (b) the additional temperature sensors.
